(19) United States
(12) Patent Application Publication
(10) Pub. No.: US 2026/0283154 A1
(43) Pub. Date: Sep. 24, 2026

(54) CLOTHIANIDIN COMPOSITIONS AND METHODS OF USE THEREOF

(71) Applicant: Valent U.S.A. LLC, San Ramon, CA (US)

(72) Inventor: Jane Liu, Milpitas, CA (US)

(21) Appl. No.: 19/571,628

(22) Filed: Mar. 19, 2026

Related U.S. Application Data
(60) Provisional application No. 63/774,810, filed on Mar. 20, 2025.

(51) Int. Cl. A01N 47/44; A01N 25/04; A01P 7/04

(52) U.S. Cl. CPC A01N 47/44; A01N 25/04; A01P 7/04

(57) ABSTRACT

The present invention is directed to agricultural compositions comprising clothianidin and a natural wax having a specific gravity of 1.015 grams per cubic centimeter. The present invention is further directed to seed treatment compositions comprising clothianidin, wherein the composition does not comprise a binder. The present invention is further directed to agricultural compositions comprising clothianidin, glycerol, sorbitol, a graft copolymer, sodium salt of naphthalene sulfonate condensate, an acrylic (type) co-polymer having a backbone containing a carboxylated ethylenically unsaturated monomer and a non-carboxylated ethylenically unsaturated monomer, a silicone-based antifoaming agent, xanthan gum and a natural wax having a specific gravity of 1.015 grams per cubic centimeter. The present invention is further directed to methods of controlling a pest comprising applying compositions of the present invention to an area in need of pest control.

### FIELD OF THE INVENTION

The present invention is directed to agricultural compositions comprising clothianidin and a natural wax having a specific gravity of 1.015 grams per cubic centimeter. The present invention is further directed to seed treatment compositions comprising clothianidin, wherein the composition does not comprise a binder. The present invention is further directed to agricultural compositions comprising clothianidin, glycerol, sorbitol, a graft copolymer, sodium salt of naphthalene sulfonate condensate, an acrylic (type) co-polymer having a backbone containing a carboxylated ethylenically unsaturated monomer and a non-carboxylated ethylenically unsaturated monomer, a silicone-based antifoaming agent, xanthan gum and a natural wax having a specific gravity of 1.015 grams per cubic centimeter. The present invention is further directed to methods of controlling a pest comprising applying compositions of the present invention to an area in need of pest control.

### BACKGROUND OF THE INVENTION

Arthropod pests, including insects and mites, are one of the major threats to human welfare, exert continued stress on the food supply and transmit a broad array of medical and veterinary diseases. Insect pests can cause severe and costly damage to crops, ornamental plants and stored foods. Further, insect and mite pests transmit diseases in and among humans resulting in reduced life expectancy, reduced quality of life and increased medical costs.

Aphids are highly problematic and costly pests of cultivated plants. There are approximately 250 described species of aphids that are known to eat crops, trees and ornamental plants. Aphids feed on the nectar of plants causing decreased growth rates, low yields and death. Aphids are also vectors for many microscopic plant pathogens spreading disease from plant to plant. Efforts to control aphids include synthetic pesticide application and the introduction of natural predators. While aphids have numerous natural predators such as ladybirds and parasitic wasps, predators and parasitoids alone are not effective at preventing crop plant damage by aphids. Unfortunately, aphids have also developed resistance to many common pesticides.

Another costly insect pest is wireworms. Wireworms feed primarily on grass crops. Wireworm infestations can result in serious crop damage. Wireworms are especially destructive to corn. When corn is infested by wireworm it often results in large loss of the crop.

Clothianidin is available as the active ingredient in NipsIt INSIDE®. NipsIt INSIDE® is a seed treatment that contains 47.8% w/w clothianidin and is a registered trademark of and available from Valent U.S.A. LLC. NipsIt INSIDE® has proven effective in controlling aphids and wireworms. However, NipsIt INSIDER contain many ingredients that have been found to have deleterious effects on the surrounding environment.

Accordingly, there is a need in the art for clothianidin composition that is environmentally friendly.

### SUMMARY OF THE INVENTION

The present invention is directed to agricultural compositions comprising clothianidin and a natural wax having a specific gravity of 1.015 grams per cubic centimeter.

The present invention is further directed to seed treatment compositions comprising clothianidin, wherein the composition does not comprise a binder.

The present invention is further directed to agricultural compositions comprising clothianidin, glycerol, sorbitol, a graft copolymer, sodium salt of naphthalene sulfonate condensate, an acrylic (type) co-polymer having a backbone containing a carboxylated ethylenically unsaturated monomer and a non-carboxylated ethylenically unsaturated monomer, a silicone-based antifoaming agent, xanthan gum and a natural wax having a specific gravity of 1.015 grams per cubic centimeter.

The present invention is further directed to methods of controlling a pest comprising applying the composition of claim 1 to an area in need of pest control.

### DETAILED DESCRIPTION OF THE INVENTION

Applicant has discovered binder free clothianidin compositions that reduce dust-off when applied to seeds. Further, these compositions are free of microplastics.

In one embodiment, the present invention is directed to agricultural compositions comprising clothianidin and a natural wax having a specific gravity of 1.015 grams per cubic centimeter.

In a preferred embodiment, the compositions of the present invention do not comprise a binder.

In another preferred embodiment, the compositions of the present invention do not comprise microplastics.

Clothianidin may be present in compositions of the present invention at a concentration from about 1% to about 60% w/w, preferably from about 10% to about 60% w/w, even more preferably from about 40% to about 60% w/w and most preferably at about 47.8% w/w.

Natural wax may be present in compositions of the present invention at a concentration from about 1% to about 20% w/w, preferably from about 1% to about 15% w/w, even more preferably from about 3% to about 10% w/w and yet even more preferably from about 4% to about 10% w/w and most preferably at about 8% w/w.

In another preferred embodiment, the compositions of the present invention further comprise one or more excipients selected from the group consisting of dispersants, wetting agents, defoamers, preservatives, thickeners and humectants.

Dispersants suitable for use in the present invention include, but are not limited to, graft copolymers, an acrylic (type) co-polymer having a backbone containing a carboxylated ethylenically unsaturated monomer, a non-carboxylated ethylenically unsaturated monomer, and mixtures thereof.

Dispersants may be present in compositions of the present invention at a concentration from about 0.1% to about 20% w/w, more preferably from about 1% to about 10% w/w, even more preferably from about 1% to about 5% w/w and most preferably at about 1%, 1.75% or about 5% w/w.

Wetting agents suitable for use in the present invention include, but are not limited to, sodium salt of naphthalene sulfonate condensate, polyoxyethylene tristyrylphenol phosphate, potassium salt, a poly(ethylene oxide)-poly(propylene oxide)-poly(ethylene oxide) block copolymer. In a preferred embodiment, the wetting agent is sodium salt of naphthalene sulfonate condensate and mixtures thereof.

Wetting agents may be present in compositions of the present invention at a concentration from about 0.1% to about 10% w/w, preferably from about 0.5% to about 5% w/w, even more preferably from about 0.5% to about 2.0% and most preferably at about 1.0% or 1.75% w/w.

Defoamers suitable for use in the present invention include, but are not limited to, a silicone-based antifoaming agent, a silicone emulsion, vegetable oils, acetylenic glycols, and high molecular weight adducts of propylene oxide and lower polyoxyethylene and polyoxypropylene block polymers (wherein the number of octyl-, nonly- and phenylpolyoxyethylene/ethylene oxide units is >5) and long-chain alcohols, 2,4,7,9-tetramethyl-5-decyne-4,7-diol and mixtures thereof. Surfynol® 104PG-50 (CAS #126-86-3) is one source of 2,4,7,9-tetramethyl-5-decyne-4,7-diol and is a registered trademark of and available from Air Products and Chemicals Inc. In a preferred embodiment, the defoamer is a silicone-based antifoaming agent.

Defoamers may be present in compositions of the present invention at a concentration from about 0.01% to about 1% w/w, preferably from about 0.05% to about 0.5% w/w, more preferably form about 0.2% to about 0.4% w/w and even more preferably at about 0.3% w/w.

Humectants suitable for use in the present invention include, but are not limited to, liquid humectants, solid humectants and mixtures thereof.

Liquid humectants suitable for use in the present invention include, but are not limited to, glycerol, polypropylene glycols and diethylene or polyethylene glycols, ethyl hexanediol, hexylene glycol, butylene glycol, propylene glycol, dipropylene glycol, tripropylene glycol, polypropylene-5-laureth-5, polyglycerol cocoate, sorbitol, fructose, glycine, inositol, panthenol and mixtures thereof. In a preferred embodiment, the liquid humectant is glycerol.

Humectants suitable for use in the present invention include, but are not limited to, polyhydric alcohols and sugars such as sorbitol. In a preferred embodiment, the humectant is a solid humectant, more preferably sorbitol.

Humectants may be present in compositions of the present invention at a concentration from about 1% to about 50% w/w, preferably from about 1% to about 20% w/w, even more preferably from about 1% to about 10% w/w and most preferably at about 3% or about 7% w/w.

Preservatives suitable for use in the present invention include, but are not limited to, a mixture of 5-chloro-2-methyl-4-isothiazolin-3-one and 2-methyl-4-isothiazolin-3-one, 1,2-benzisothiazolin-3-one, a mixture of 1, 2-benzisothiazolin-3-one and 2-bromo-2-nitro-1,3-propanediol, a mixture of 5-chloro-2-methyl-1,2-thiazol-3 (2H)-one & 2-Methyl-1,2-thiazol-3 (2H)-one, bronopol and mixtures thereof. In a preferred embodiment, the preservative is 19.3% 1,2-benzisothiazolin-3-one.

Preservatives may be present in compositions of the present invention at a concentration from about 0.1% to about 1% w/w, preferably from about 0.1% to about 0.3% w/w, and most preferably at about 0.25% w/w.

Thickeners suitable for use in the present invention include, but are not limited to, magnesium aluminum silicate, hydrophilic fumed silica, aluminum oxide, hydroxy alkyl celluloses, xanthan gum and mixtures thereof. In a preferred embodiment, the thickener is xanthan gum.

Thickeners may be present at a concentration from about from about 0.01% to about 5% w/w, preferably from about 0.05% to about 2% w/w, more preferably from about 0.1% to about 1% w/w, and most preferably at about 0.1% w/w.

Water may be present in compositions of the present invention at a concentration from about 1% to about 99% w/w, preferably from about 10% to about 89% w/w, more preferably from about 20% to about 40% w/w and even more preferably from about 20% to about 30% w/w and most preferably about 26.35% w/w.

In another embodiment the present invention is directed to methods of controlling a pest comprising applying the compositions of the invention to an area in need of pest control.

Pests that may be controlled by compositions of the present invention include, but are not limited to, aphids and wireworms.

As used herein, “aphids” refers to pests that belong to the SuperFamily Aphidoidea of Order Hemiptera.

As used herein, “wireworm” refers to pests that belong to the Family Elateridae of the Order Coleoptera.

As used herein, “controlling a pest” refers to decreasing the negative impact of the pest on plants or animals to a level that is desirable to the grower or animal.

As used herein, “an area in need of pest control” refers to any area where the pest is present during any life stage. One environment likely to be treated by the methods of the present invention includes the plants, the plant propagation material and that the pest is living on/in and the surrounding soil. The pest's environment may also include harvested plants, gardens, fields, greenhouses, or other buildings, and various indoor surfaces and structures, such as furniture including beds, and furnishings including books, clothing, etc.

As used herein, the term “plant propagation material” refers to seeds and seedlings of all kinds (fruit, tubers, and grains), clonal and micro propagated plants, and the like.

Throughout the application, the singular forms “a,” “an,” and “the” include plural reference unless the context clearly dictates otherwise.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

These representative embodiments are in no way limiting and are described solely to illustrate some aspects of the invention.

Further, the following examples are offered by way of illustration only and not by way of limitation.

### EXAMPLES

TABLE 1

| % w/w | Function | A | B | #1 | #2 | #3 | #4 | #5 | #6 | #7 |
|---|---|---|---|---|---|---|---|---|---|---|
| Clothianidin | Active | 47.8 | 47.8 | 47.8 | 47.8 | 47.8 | 47.8 | 47.8 | 47.8 | 47.8 |
| Graft copolymer | Dispersant | 1.17 | 5.0 | 4.0 | 4.0 | 4.0 | 4.0 | 4.0 | 4.0 | 4.0 |
| Acrylic (type) copolymer having | Dispersant | — | 1.5 | 1.0 | 1.0 | 1.0 | 1.0 | 1.0 | 1.0 | 1.0 |
| a backbone containing a | | | | | | | | | | |
| carboxylated ethylenically | | | | | | | | | | |
| unsaturated monomer and a | | | | | | | | | | |
| non-carboxylated ethylenically | | | | | | | | | | |
| unsaturated monomer | | | | | | | | | | |
| Polyoxyethylene tristyrylphenol | Wetting | 0.244 | — | — | — | — | — | — | — | — |
| phosphate, potassium salt | Agent | | | | | | | | | |
| A poly(ethylene oxide)- | Wetting | — | 0.5 | — | — | — | — | — | — | — |
| poly(propylene oxide)- | Agent | | | | | | | | | |
| poly(ethylene oxide) block | | | | | | | | | | |
| copolymer | | | | | | | | | | |
| Sodium salt of naphthalene | Wetting | — | — | 1.0 | 1.0 | 1.0 | 1.0 | 1.0 | 1.0 | 1.0 |
| sulfonate condensate | Agent | | | | | | | | | |
| 2,4,7,9-tetramethyl-5-decyne- | Defoamer | 0.063 | — | — | — | — | — | — | — | — |
| 4,7-diol | | | | | | | | | | |
| Silicone-based antifoaming agent | Defoamer | — | 0.3 | 0.3 | 0.3 | 0.3 | 0.3 | 0.3 | 0.3 | 0.3 |
| 19.3% 1,2-benzisothiazolin-3-one | Preservative | — | 0.2 | 0.25 | 0.25 | 0.25 | 0.25 | 0.25 | 0.25 | 0.25 |
| A mixture of 5-chloro-2-methyl- | Preservative | 0.05 | — | — | — | — | — | — | — | — |
| 4-isothiazolin-3-one and 2-methyl- | | | | | | | | | | |
| 4-isothiazolin-3-one | | | | | | | | | | |
| Xanthan gum | Thickener | 0.035 | 0.1 | 0.1 | 0.1 | 0.1 | 0.1 | 0.1 | 0.1 | 0.1 |
| Sorbitol (70% solution) | Solid | 6.14 | — | 7.0 | 7.0 | 7.0 | 7.0 | 7.0 | 7.0 | 7.0 |
| | Humectant | | | | | | | | | |
| Glycerol | Liquid | 4.3 | 6.0 | 3.0 | 3.0 | 3.0 | 3.0 | 3.0 | 3.0 | 3.0 |
| | Humectant | | | | | | | | | |
| Carnauba wax | Slip Agent | 3.0 | 3.0 | — | — | — | — | — | — | — |
| Natural wax | Slip Agent | — | — | — | 4 | 4 | 4 | 8 | — | — |
| Acrylic copolymer aqueous emulsion | Microplastic | — | 3.0 | — | — | — | — | — | — | — |
| | Binder | | | | | | | | | |
| Vinyl acetate ethylene copolymer | Microplastic | 2.8 | — | — | — | — | — | — | — | — |
| emulsion | Binder | | | | | | | | | |
| Ethoxylated alcohol | Microplastic- | — | — | — | — | 4 | — | — | 8 | — |
| | free Binder | | | | | | | | | |
| Microfibrillated cellulose | Microplastic- | — | — | — | — | — | 4 | — | — | 8 |
| | free Binder | | | | | | | | | |
| Polyvinyl alcohol | Binder | 5.67 | — | — | — | — | — | — | — | — |
| Water | | Q.S. | Q.S. | Q.S. | Q.S. | Q.S. | Q.S. | Q.S. | Q.S. | Q.S. |

| % w/w | Function | #8 | #9 | #10 | #11 |
|---|---|---|---|---|---|
| Clothianidin | Active | 47.8 | 47.8 | 47.8 | 47.8 |
| Graft copolymer | Dispersant | 4.0 | 4.0 | 4.0 | 4.0 |
| Acrylic (type) copolymer having | Dispersant | 1.0 | 1.0 | 1.75 | 1.75 |
| a backbone containing a | | | | | |
| carboxylated ethylenically | | | | | |
| unsaturated monomer and a | | | | | |
| non-carboxylated ethylenically | | | | | |
| unsaturated monomer | | | | | |
| Sodium salt of naphthalene | Wetting Agent | 1.0 | 1.0 | 1.75 | 1.75 |
| sulfonate condensate | | | | | |
| Silicone-based antifoaming agent | Defoamer | 0.3 | 0.3 | 0.3 | 0.3 |
| 19.3% 1,2-benzisothiazolin-3-one | Preservative | 0.25 | 0.25 | 0.25 | 0.25 |
| A mixture of 5-chloro-2-methyl- | Preservative | 0.1 | 0.1 | 0.1 | 0.1 |
| 1,2-thiazol-3(2H)-one & 2-Methyl- | | | | | |
| 1,2-thiazol-3(2H)-one | | | | | |
| Bronopol (30%) | Preservative | — | 0.04 | — | 0.04 |
| Xanthan gum | Thickener | 0.1 | 0.1 | 0.1 | 0.1 |
| Sorbitol (70% solution) | Solid Humectant | 7.0 | 7.0 | 7.0 | 7.0 |
| Glycerol | Liquid Humectant | 3.0 | 3.0 | 3.0 | 3.0 |
| Natural wax | Slip Agent | 8 | 8 | 8 | 8 |
| Water | | Q.S. | Q.S. | Q.S. | Q.S. |

Michem® Lube 156P and Michem® Lube 156PFP were used as the source of carnauba wax (25% emulsion in water) and is a registered trademark of and available from Michelman Inc.

NYS2203 (a.k.a. 231178SX) was used as the source of natural wax. NYS2203 is available from Michelman. NYS2203 has a density of 8.47 pounds per gallon, a specific gravity of 1.015 grams per cubic centimeter and a viscosity of 200 to 400 centipoise.

Esentia NA-STK-COAT was used as a source of an acrylic copolymer aqueous emulsion. Esentia is available from Lamberti SPA.

Dur-O-Set® E 200 was used as the source of vinyl acetate ethylene copolymer emulsion (Dur-O-Set is a registered trademark of and available from Celanese International Corporation).

Adsee D was used as the source of ethoxylated alcohol.

Exilva® F01-L (2%) (CAS #9004-34-6) was used as the source of microfibrillated cellulose (Exilva is a registered trademark of and available from Borregaard AS).

Stepfac™ TSP PE-K (CAS #163436-84-8) was used as the source of polyoxyethylene tristyrylphenol phosphate, potassium salt (Stepfac is available from Stepan Corp).

Pluronic® P103 was used as the source of a poly(ethylene oxide)-poly(propylene oxide)-poly(ethylene oxide) block copolymer (Pluronic is a registered trademark of and available from BASF Corporation). Pluronic® P103 has an average molecular weight of 4950 and a hydrophile weight percentage of 30%.

Surfynol® 104 PG was used as the source of 2,4,7,9-tetramethyl-5-decyne-4,7-diol (Surfynol is a registered trademark of and available from Evonik Operations GMBH).

Selvol® 24-203 was used as the source of a polyvinyl alcohol (Selvol is a registered trademark of and available from Sekisui Specialty Chemicals America LLC). Selvol® 24-203 is a partially hydrolyzed (24% solution in water).

Tersperse® 2500 was used as the source of graft copolymer (Tersperse is a registered trademark of and available from Huntsman Petrochemical Corporation). Tersperse® 2500 has a density of 1.07 grams per milliliter at 25° C., a viscosity of 200 centipoise at 25° C. and an HLB value from 11 to 12.

Envi-Pol® 871 was used as the source of an acrylic (type) co-polymer having a backbone containing a carboxylated ethylenically unsaturated monomer and a non-carboxylated ethylenically unsaturated monomer (Envi-pol is a registered trademark of and available from Lamberti SPA).

Morwet® EFW was used as the source of sodium salt of naphthalene sulfonate condensate (Morwet is a registered trademark of and available from Akzo Nobel Surface Chemistry LLC).

Xiameter® 0010/1510 was used as the source of silicone-based antifoaming agent (Xiameter is a registered trademark of and available from Dow Corning Corporation).

Proxel® GXL was used as the source of 19.3% 1, 2-benzisothiazolin-3-one (Proxel is a registered trademark of Arch UK Biocides and is available from Lonza).

Acticide® MV was used as the source of a mixture of 5-chloro-2-methyl-1,2-thiazol-3 (2H)-one & 2-Methyl-1,2-thiazol-3 (2H)-one (Acticide is a registered trademark and is available from Thor GMBH).

Acticide® L30 was used as the source of bronopol (CAS #52-51-7).

Kathon® CG/ICP (CAS #26172-55-4 and 2682-20-4) is used as the source of a mixture of 5-chloro-2-methyl-4-isothiazolin-3-one and 2-methyl-4-isothiazolin-3-one, solution in water. Kathon is a registered trademark of and available from Rohm and Haas Company. Kelzan® CC was used as the source of xanthan gum (Kelzan is a registered trademark of and available from CP Kelco).

### Example 1—Preparation of a Composition of the Invention

### Method

### Liquid Carrier Preparation

Glycerol and sorbitol were added to water while mixing to create a carrier. A graft copolymer and an acrylic (type) co-polymer having a backbone containing a carboxylated ethylenically unsaturated monomer and a non-carboxylated ethylenically unsaturated monomer were then added to the carrier along with sodium salt of naphthalene sulfonate condensate. Finally, a natural wax in water and a silicone-based antifoaming agent were added to the carrier while mixing.

### Mill Base Preparation

Clothianidin Technical (99.6% purity, supplied by from Jiangsu Flag Chemical Industry Co., Ltd.) is added to the carrier while stirring for 20 minutes until all clothianidin particles were wet to create a mixture. Then using a basket mill (Dispermat AE-C equipped with TML-1 basket milling system), the mixture was milled by using 1.2-1.7 mm zirconium oxide beads and grinding the mixture to the median particle size range of 1.8 to 2.8 microns.

### Finishing Formulation Preparation

In a separate container, 0.1% of xanthan gum and 0.25% of 1, 2-benzisothiazolin-3-one were pre-dissolved in water to create a solution. The solution, and remaining water were added to the mill base while mixing for 45 minutes to 1 hour.

### Example 1—Composition Handling Stability

### Method

The compositions from Table 1, above, were submitted to a corn dust-off experiment. This dust-off experiment was conducted to determine the amount of dust produced in grams per 100 kilograms of corn seeds. Specifically, corn treated with one of the compositions from Table 1, above, were submitted to elevator handling test. Cyclone dust collectors separated airborne particulate during the weighing operation to determine the amount of “dust-off”.

TABLE 2

| | L Dust Seeds | H Dust Seeds |
|---|---|---|
| UTC | 0.404 | 0.65 |
| Composition A | 2.687 | 3.05 |
| Composition B | 2.187 | 2.4 |
| Composition #1 | 3.556 | 5.6 |
| Composition #2 | 2.222 | 2.675 |
| Composition #3 | 2.35 | 1.65 |
| Composition #4 | 1.348 | 2.45 |
| Composition #5 | 1.33 | 1.25 |
| Composition #6 | 4.091 | 5.205 |
| Composition #7 | 3.538 | 4.925 |

### Results

As demonstrated in Table 2, above, Compositions #2-#5 each of which contain natural wax had very low dusting-off properties. Further, compositions #2 and #5, each of which do not contain a binder had very low dusting-off properties, wherein composition #5 had the best dusting-off properties of all compositions.

### Example 2—Composition Storage Stability

### Methods

Compositions A, B and #5 from Table 1, above, were prepared and subjected to 40° C. for 16 weeks, 50° C. for 8 weeks, 54° C. for 2 weeks, 4° C. for 16 weeks, −20° C. for 8 weeks and 5 cycles of freeze/thaw (“F/T”). Following storage at the accelerated storage conditions, the 3 compositions were measured for syneresis, 90° rotation flow, bottom clear time, sprayability, particle size and viscosity. Results of this experiment are shown in Tables 3-5, below.

### Syneresis

Syneresis was determined by placing the composition in a 125-milliliter high density polyethylene (HDPE) bottle at the above-mentioned storage conditions. The height of the top clear liquid phase was then measured. Syneresis is calculated using the following equation: Height of top clear liquid phase/height of total sample.

A high syneresis value indicates poor formulation stability.

### Bottom Clear Time

Bottom clear time is the time until the composition flows away from the container bottom when 62.5 milliliters of the composition is placed in a 125-milliliter plastic jar and placed on its side. A high bottom clear time indicates poor flowability stability.

### Sprayability

Sprayability is based on the following test procedure and calculation. A 100-mesh (150 micrometer) sieve is weighed and the weight is recorded as the tare weight (“W0”). The sieve is then placed over a wide mouth jar.

50 grams of a composition (“W”) is weighed and added to 600 milliliters of tap water, the composition was then stirred for approximately two minutes to create a dispersion.

The entire dispersion was poured through the sieve followed by rinsing. Rinsing was done using tap water at a flow rate at about 1.5 liters per minute for one minute. The sieve with the residue was then placed in a drying oven and dried to create the dry sieve with the residue (“W1”). Percent sprayability was then calculated with the following equation: (W1−W0)/W*100.

A large percent sprayability indicates poor formulation stability leading to nozzle clogging during field application. Formulation should have a sprayability no more than 0.05% w/w under all conditions.

### Physical Stability

Physical stability is determined by particle size. Particle sizes were measured for each composition. D (v, 0.1), D (v, 0.5) and D (v, 0.9) values were measured. D (v, X) denotes the proportion of particles whose diameter measured below the given value in microns.

### Rheology Properties

The rheological properties including viscosity, G′, G″ was measured using Haak Mars Modular Advanced Rheometer System made by Thermo Scientific, model number: MARS 2.

TABLE 3

| Composition A | Initial | 54° C. 2 w | F/T | 50° C. 8 w | −20° C. 8 w | 4° C. 16 w | 40° C. 16 w |
|---|---|---|---|---|---|---|---|
| Syneresis | — | 8.11% | 0.01% | 14.29% | 0.00% | 5.41% | 14.29% |
| 90° rotation | — | flow | flow | slow flow | flow | flow | Slow moving |
| Bottom Clear Time | — | 1.83 m | 18 s | 7.5 m | 10 s | 1 m | 1.75 m |
| % Sprayability | 0.0261 | 0.0120 | 0.0062 | 0.0051% | 0.0011% | 0.0006% | 0.0006% |
| Particle size D | 0.725 | 0.804 | 0.816 | 0.829 | 0.811 | 0.725 | 0.772 |
| (v, 0.1) | | | | | | | |
| Particle size D | 1.647 | 2.207 | 1.77 | 2.26 | 1.75 | 1.649 | 1.792 |
| (v, 0.5) | | | | | | | |
| Particle size D | 3.803 | 5.888 | 3.728 | 6.72 | 3.671 | 3.711 | 4.164 |
| (v, 0.9) | | | | | | | |
| Viscosity at | 5839 | 2656 | 2313 | 20210 | 19880 | 2588 | 17060 |
| 20° C. 1 sec − 1 | | | | | | | |
| Viscosity at | 353.7 | 420.4 | 368.2 | 607.3 | 604.1 | 339.3 | 527.8 |
| 20° C. 50 sec − 1 | | | | | | | |
| Viscosity at | 5409 | 47.82 | 17.74 | 15720 | 20360 | 163.7 | 9595 |
| 20° C. G′ | | | | | | | |
| (t = 0.1 Pa) | | | | | | | |
| Viscosity at | 8070 | 17.46 | 6.334 | 34250 | 6823 | 57.92 | 2190 |
| 20° C. G″ | | | | | | | |
| (t = 0.1 Pa) | | | | | | | |

TABLE 4

| Composition B | Initial | 54° C. 2 w | F/T | 50° C. 8 w | −20° C. 8 w | 4° C. 16 w | 40° C. 16 w |
|---|---|---|---|---|---|---|---|
| 90° rotation | — | flow | flow | flow | not flowing | flow | flow |
| Bottom Clear Time | — | 0 | 0 | 2 s | 16 m | 2 s | 8 s |
| % Sprayability | 0.047 | 0.028 | 0.002 | 0.0386 | 6.6711 | 0.0014 | 0.309 |
| Particle size D | 0.731 | 0.773 | 0.704 | 0.823 | 61.1 | 0.654 | 0.944 |
| (v, 0.1) | | | | | | | |
| Particle size D | 1.820 | 1.94 | 1.77 | 2.14 | 374 | 1.69 | 2.92 |
| (v, 0.5) | | | | | | | |
| Particle size D | 4.580 | 4.84 | 4.32 | 5.46 | 891 | 5.61 | 83.3 |
| (v, 0.9) | | | | | | | |

TABLE 5

| Composition#5 | Initial | 54° C. 2 w | F/T | 50° C. 8 w | −20° C. 8 w | 4° C. 16 w | 40° C. 16 w |
|---|---|---|---|---|---|---|---|
| Bottom Clear Time | — | 2 s | 2 s | 2 s | 2 s | 2 s | 2 s |
| % Sprayability | — | 0.0276 | 0.0049 | 0.0261 | 0.0008 | 0.0006 | 0.0012 |
| Particle size D | 0.798 | 0.823 | 0.777 | 0.811 | 0.729 | 0.801 | 0.916 |
| (v, 0.1) | | | | | | | |
| Particle size D | 2.230 | 2.74 | 2.43 | 2.72 | 2.00 | 2.32 | 2.825 |
| (v, 0.5) | | | | | | | |
| Particle size D | 5.020 | 6.48 | 5.46 | 9.96 | 7.75 | 5.05 | 5.856 |
| (v, 0.9) | | | | | | | |
| Viscosity at | — | — | — | — | — | 2749.3 | 2513.0 |
| 20° C. 1 sec − 1 | | | | | | | |
| Viscosity at | — | — | — | — | — | 211.67 | 199.01 |
| 20° C. 50 sec − 1 | | | | | | | |
| Viscosity at | | | | | | 59.637 | 43.70 |
| 20° C. G′ | | | | | | | |
| (t = 0.1 Pa) | | | | | | | |
| Viscosity at | — | — | — | — | — | 33.832 | 25.09 |
| 20° C. G″ | | | | | | | |
| (t = 0.1 Pa) | | | | | | | |

As demonstrated in Tables 3-5, Composition #5 provides storage stability as good or better than the commercially available NipsIt INSIDE® (i.e. Composition A).

What is claimed is:

1. An agricultural composition comprising clothianidin and a natural wax having a specific gravity of 1.015 grams per cubic centimeter.

2. The composition of claim 1, wherein the composition does not comprise a binder.

3. The composition of claim 1, wherein the composition does not comprise microplastics.

4. The composition of claim 1, further comprising one or more excipients selected from the group consisting of dispersants, wetting agents, defoamers, preservatives, thickeners and humectants.

5. The composition of claim 4, wherein the dispersants are selected from the group consisting of graft copolymers, an acrylic (type) co-polymer having a backbone containing a carboxylated ethylenically unsaturated monomer and a non-carboxylated ethylenically unsaturated monomer and mixtures thereof.

6. The composition of claim 4, wherein the wetting agents are selected from the group consisting of sodium salt of naphthalene sulfonate condensate, polyoxyethylene tristyrylphenol phosphate, potassium salt, a poly(ethylene oxide)-poly(propylene oxide)-poly(ethylene oxide) block copolymer and mixtures thereof.

7. The composition of claim 4, wherein the defoamers are selected from the group consisting of a silicone-based antifoaming agent, a silicone emulsion, vegetable oils, acetylenic glycols, high molecular weight adducts of propylene oxide, lower polyoxyethylene and polyoxypropylene block polymers, long-chain alcohols, 2,4,7,9-tetramethyl-5-decyne-4,7-diol and mixtures thereof.

8. The composition of claim 4, wherein the preservatives are selected from the group consisting of a mixture of 5-chloro-2-methyl-4-isothiazolin-3-one and 2-methyl-4-isothiazolin-3-one, 1,2-benzisothiazolin-3-one, a mixture of 5-chloro-2-methyl-1,2-thiazol-3 (2H)-one & 2-Methyl-1,2-thiazol-3 (2H)-one, bronopol, a mixture of 1, 2-benzisothiazolin-3-one and 2-bromo-2-nitro-1,3-propanediol and mixtures thereof.

9. The composition of claim 4, wherein the thickeners are selected from the group consisting of magnesium aluminum silicate, hydrophilic fumed silica, aluminum oxide, hydroxy alkyl celluloses, xanthan gum and mixtures thereof.

10. The composition of claim 4, wherein the humectants are selected from the group consisting of glycerol, polypropylene glycols and diethylene or polyethylene glycols, ethyl hexanediol, hexylene glycol, butylene glycol, propylene glycol, dipropylene glycol, tripropylene glycol, polypropylene-5-laureth-5, polyglycerol cocoate, sorbitol, fructose, glycine, inositol, panthenol and mixtures thereof.

11. A seed treatment composition comprising clothianidin, wherein the composition does not comprise a binder.

12. The composition of claim 1, wherein the composition does not comprise microplastics.

13. The composition of claim 11, wherein the composition comprises a natural wax having a specific gravity of 1.015 grams per cubic centimeter.

14. The composition of claim 11, further comprising one or more excipients selected from the group consisting of dispersants, wetting agents, defoamers, preservatives, thickeners and humectants.

15. An agricultural composition comprising clothianidin, glycerol, sorbitol, a graft copolymer, sodium salt of naphthalene sulfonate condensate, an acrylic type co-polymer having a backbone containing a carboxylated ethylenically unsaturated monomer and a non-carboxylated ethylenically unsaturated monomer, a silicone-based antifoaming agent, xanthan gum and a natural wax having a specific gravity of 1.015 grams per cubic centimeter.

16. The composition of claim 15, further comprising 19.3% 1,2-benzisothiazolin-3-one.

17. The composition of claim 15, wherein the composition is a seed treatment composition.

18. The composition of claim 15, wherein:
clothianidin is at a concentration from about 10% to about 60% w/w;
glycerol is at a concentration from about 1% to about 20% w/w;
sorbitol is at a concentration from about 1% to about 20% w/w;
the graft copolymer is at a concentration from about 1% to about 10% w/w;
sodium salt of naphthalene sulfonate condensate is at a concentration from about 0.1% to about 10% w/w;
the acrylic type co-polymer having a backbone containing a carboxylated ethylenically unsaturated monomer and a non-carboxylated ethylenically unsaturated monomer is at a concentration from about 0.1% to about 10% w/w;
the silicone-based antifoaming agent is at a concentration from about 0.01% to about 1% w/w;
xanthan gum is at a concentration from about 0.01% to about 5% w/w; and
the natural wax is at a concentration from about 1% to about 20% w/w,
wherein w/w denotes weight by weight of the total composition.

19. A method of controlling a pest comprising applying the composition of claim 1 to an area in need of pest control.

20. The method of claim 19, wherein the pest is an aphid or a wireworm.
